(19) United States
(12) Patent Application Publication
(10) Pub. No.: US 2001/0001525 A1
(43) Pub. Date: May 24, 2001

(54) Apparatus and methods for lifting containers

(76) Inventors: John Shepard, Bolingbrook, IL (US); David Bolenbaugh, Ohio City, OH (US); Arthur R. Tomczak, Naperville, IL (US)

Correspondence Address: Vorys, Sater, Seymour and Pease LLP, Eleventh Floor, 1828 L Street, N. W., Washington, DC, 20036-5109, US

(21) Appl. No.: 09/760,750

(22) Filed: Jan. 17, 2001

Related U.S. Application Data
(63) Continuation of application No. 09/557,608, filed on Apr. 25, 2000.

(51) Int. Cl. B66C 1/62

(52) U.S. Cl. 294/81.61; 294/90; 294/104

(57) ABSTRACT

Apparatus for lifting an open top container, such as a drum, comprises a plurality of clamps each having shaped outer and inner jaws for frictionally gripping therebetween a corresponding sidewall portion of the container. A lifting mechanism closes the clamps and then lifts the container with the container suspended from the clamps. The apparatus is constructed so that the weight of the container increases the clamping pressure as the container is lifted. Other loads having an upright tubular sidewall can also be lifted. In one embodiment, the lifting mechanism employs wedges for closing the clamps, and in another embodiment the lifting mechanism employs linkages for closing the clamps.

### BACKGROUND OF THE INVENTION

This invention is concerned with apparatus and methods for lifting containers, more particularly open top, straight sidewall containers that need not have projections or indentations to permit lifting.

Certain containers, for example fiberboard drums, have straight vertical sidewalls without projections or indentations, and do not lend themselves to known lifting apparatus which rely on engagement of lifting elements with projections or indentations in order to lift the container.

### SUMMARY OF THE INVENTION

An object of the invention is to provide a simple, yet highly effective, apparatus and method for lifting containers with straight or smooth sidewalls, devoid of projections or indentations, although, as will become apparent later, the invention is also capable of lifting other types of containers, as well as loads having upright tubular sidewalls, such as vertical sections of pipe.

In one of its implementations, the invention employs a plurality of clamps constructed and disposed to grip spaced sidewall portions of a container, frictionally. Each clamp has cooperable outer and inner jaws shaped to conform with the configuration of the sidewall. The outer jaws are in close proximity with external surfaces of the sidewall, and the inner jaws are movable relative to the outer jaws to engage internal surfaces of the sidewall. The clamps are operated by a lifting mechanism that closes the clamps upon the sidewall portions and that thereafter lifts the container with the container suspended from the clamps. The construction of the lifting mechanism is such that the weight of the lifted container (and/or its contents) increases the clamping pressure. In one embodiment, wedges are used to move the inner jaws, and in another embodiment linkages are used to move the inner jaws.

### BRIEF DESCRIPTION OF THE DRAWINGS

The invention will be further described in conjunction with the accompanying drawings, which illustrate preferred (best mode) embodiments and wherein:

FIG. 1 is a top plan view of a first embodiment of the invention shown in a position preparatory to lifting a container;

FIG. 2 is a side elevation view corresponding to FIG. 1;

FIG. 3 is a similar side elevation view showing an initial phase of container lifting;

FIG. 4 is a top plan view of a frame supporting outer clamp jaws in the first embodiment;

FIG. 5 is a side elevation view corresponding to FIG. 4;

FIG. 6 is a side elevation view of a pivot member supporting an inner clamp jaw in the first embodiment;

FIG. 7 is top plan view corresponding to FIG. 6;

FIG. 8 is a side elevation view of a lifting member supporting wedges in the first embodiment;

FIG. 9 is an end elevation view corresponding to FIG. 8;

FIG. 10 is a top plan view of a second embodiment of the invention shown in a position preparatory to lifting a container;

FIG. 11 is a side elevation view corresponding to FIG. 10;

FIG. 12 is a similar side elevation view showing an initial phase of container lifting; and

FIG. 13 is a fragmentary enlarged horizontal sectional view taken along line 13-13 of FIG. 11 and showing an arrangement for locking lifting apparatus in the position shown in FIG. 11.

### DETAILED DESCRIPTION OF THE INVENTION

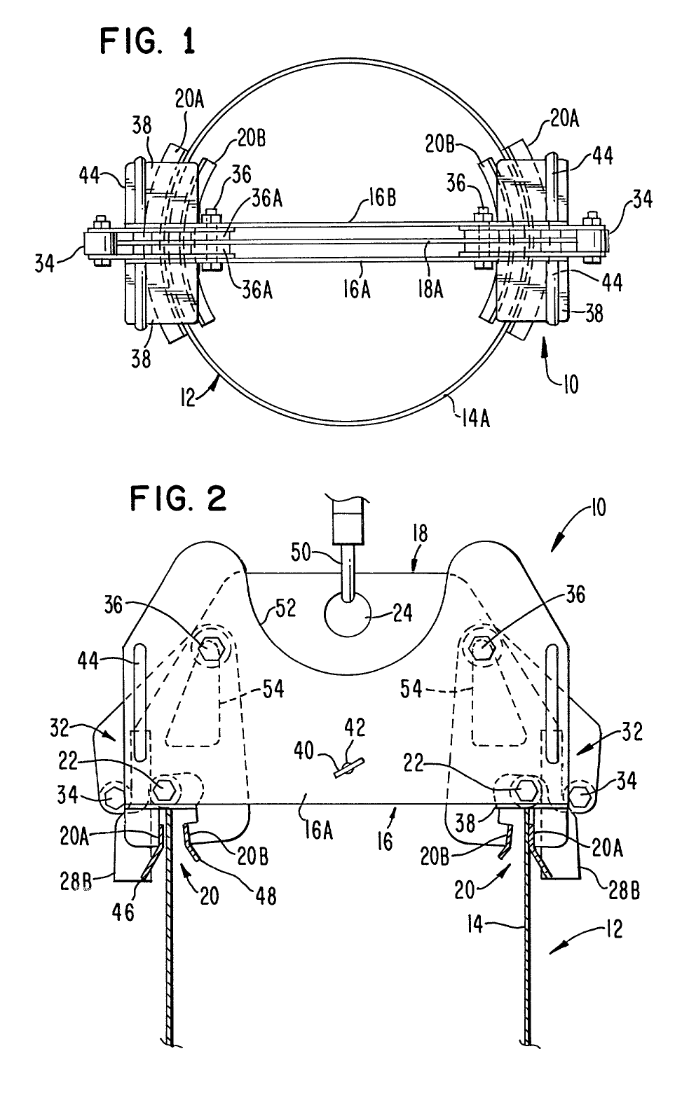

A first embodiment of the invention is shown in FIGS. 1-9.

In FIGS. 1-3, the lifting apparatus 10 is positioned over a container 12 such as a fiberboard drum having a straight vertical sidewall 14. The drum has no beading, crimping, or other formations engaged by conventional lifting apparatus. The lifting apparatus relies entirely on frictional forces for lifting the container.

The lifting apparatus comprises a frame 16, a lifting member 18, and a plurality of clamps 20 that are opened and closed in response to movement of the lifting member relative to the frame.

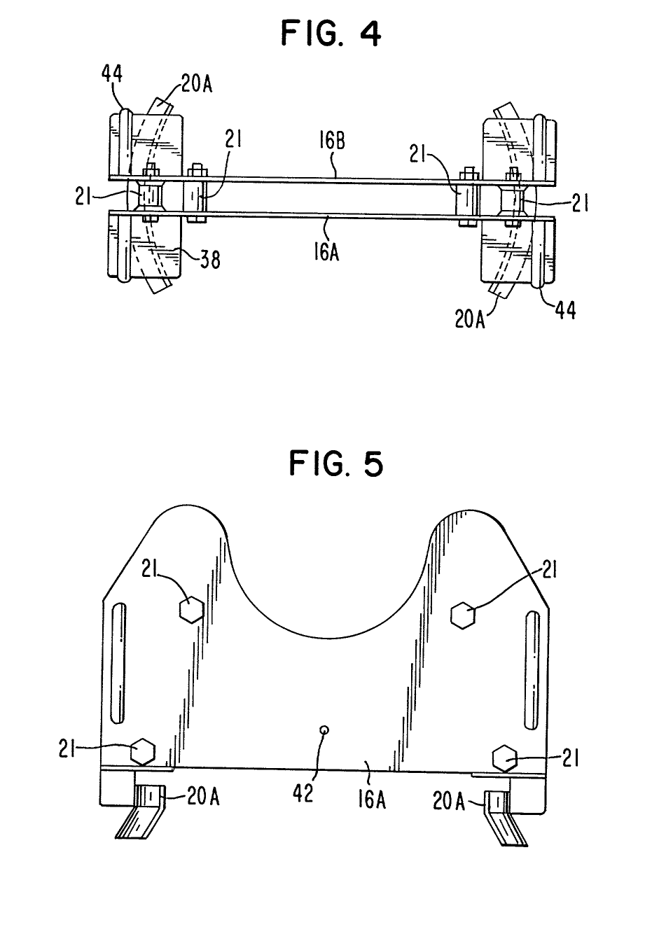

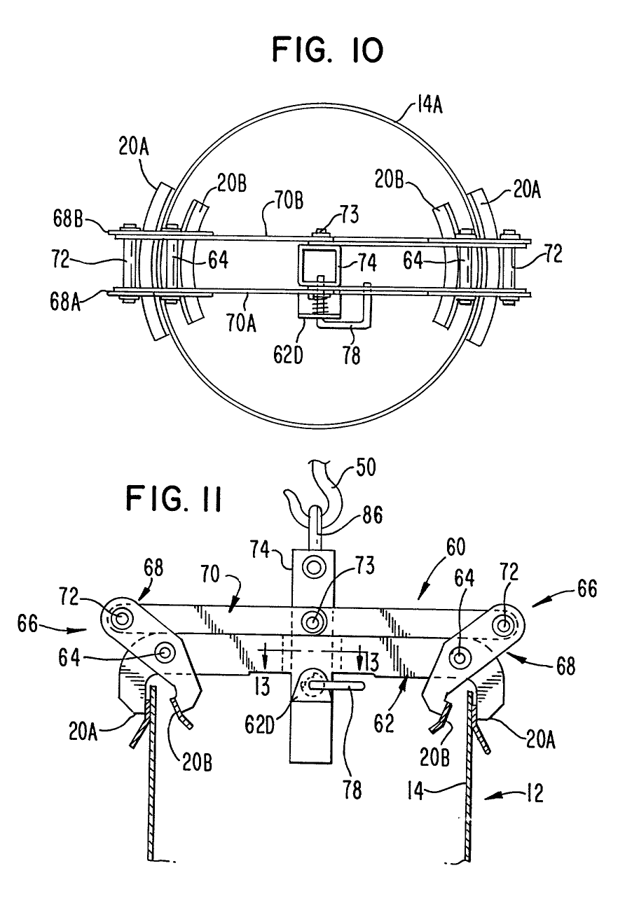

The frame 16 comprises a pair of frame parts constituted by parallel plates 16A,16B, which are joined in a conventional manner. In FIGS. 4 and 5 the frame plates are shown temporarily separated by spacers 21 prior to assembly with bearings 22 and pivots 36 (described later). The lifting member 18 comprises a plate 18A disposed centrally between the plates 16A, 16B of the frame. As shown in FIGS. 8 and 9, the lifting member plate 18A has a pair of slots 23 (used in guiding the lifting member), a hole 24 (used in raising the lifting member), and a hole 26 (used in latching the lifting member to the frame), as described in greater detail later. Wedges 28, having bifurcated bases 28A, are fixed to opposite ends of the lifting member plate 18A, e.g., by screws 30. Each wedge has an incline surface 28B facing outwardly and a straight vertical surface 28C facing inwardly.

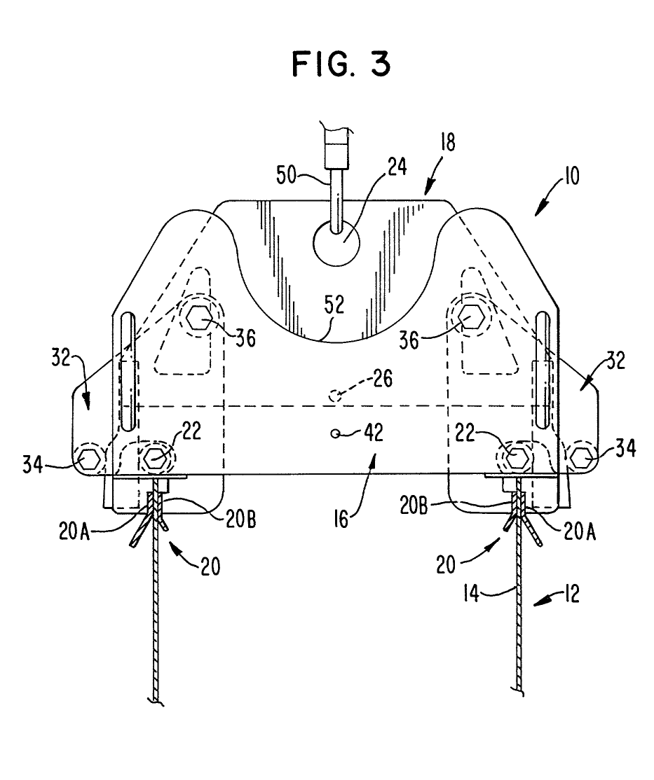

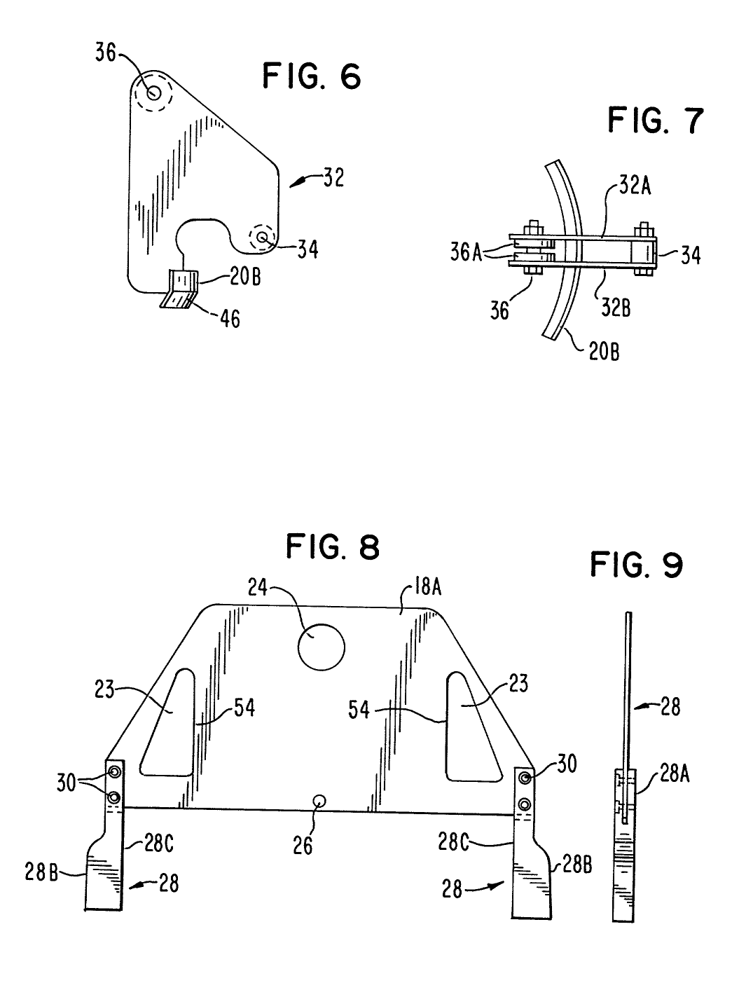

As shown in FIGS. 1-3, each clamp 20 has outer and inner jaws 20A and 20B. The outer jaws 20A are fixed to the frame 16, e.g., by welding (see FIGS. 4 and 5). The inner jaws 20B are fixed to pivot members 32, e.g., by welding (see FIGS. 6 and 7). Each pivot member 32 comprises a pair of parallel plates 32A, 32B joined in a conventional manner. The plates are assembled with bearings 34 and pivots 36. The pivot members are oppositely disposed and mounted on the frame 16 for pivotal movement about the axes of pivots 36. Each pivot has a pair of discs 36A that embrace the plate 18A of the lifting member as shown in FIG. 1. When the lifting member 18 is assembled with the frame 16, the pivots 36 extend through the slots 23 of the lifting member plate 18A as shown in FIGS. 2 and 3. The bearings 34 act as followers that engage the incline surfaces 28B of the wedges 28.

The jaws 20A, 20B of each clamp 20 are shaped to conform with the shape of the sidewall 14 of the container 12. In the form shown, the container has a cylindrical sidewall, and each jaw is a cylindrical section, elongated circumferentially in horizontal planes. The invention may also be used to lift containers having sidewalls that are square, rectangular, oval, octagonal, or other shapes, and the configuration of the jaws will be chosen to conform to the shape of the sidewall portions engaged by the jaws. The shaped jaw surfaces allow the lifting forces to be spread over an area of the container wall sufficient to prevent marring or deforming the container walls.

In FIGS. 1 and 2, the lifting apparatus 10 is shown supported on the top edge 14A of the sidewall 14 of the container by horizontal plates 38 fixed to and extending outwardly from opposite sides of the frame 16. The clamps 20 are shown in their fully open position, and the lifting member 18 is shown in its lowermost position relative to the frame 16. In FIG. 2 a T-shaped pin 40 is shown inserted through aligned holes 42 in the plates 16A, 16B of the frame and the hole 26 (FIG. 8) in the lifting member plate 18A, thereby latching the lifting member in its lowermost position. The frame 16 is provided with handles 44 which may be grasped to assist in positioning the lifting apparatus 10 relative to the container 12.

When the lifting apparatus is properly positioned on top of the container sidewall 14, the outer jaws 20A (fixed to the frame 16) may be spaced slightly from opposed outer surfaces of the sidewall. The outer jaws are provided with lead-in portions 46 that taper outwardly and downwardly to facilitate placement of the lifting apparatus on the container. The lead-in portions may be slotted to provide some flexibility in the outer jaws and to facilitate the shaping of the outer jaws. Similarly, the inner jaws 20B have lead-in portions 48.

To operate the lifting apparatus 10, the lifting member 18 is raised relative to the frame 16. For this purpose, the hook 50 of a hoist or other power lift mechanism may be engaged with the lifting member via the hole 24. The upper edge 52 of the frame plates 16A, 16B may be contoured as shown to expose the hole for such engagement.

After the lifting apparatus 10 has been placed on the container sidewall 14, as shown in FIGS. 1 and 2, the lifting member 18 is raised, as shown in FIG. 3. The weight of the frame 16 and the pivot members 32 is sufficient to maintain the position of the frame 16 on the container as the lifting member 18 is initially raised relative to the frame.

Raising of the lifting member 18 causes the wedges 28 to move upwardly. Movement of the lifting member relative to the frame 16 is guided by the engagement of the pivots 36 with vertical surfaces 54 of the slots 23 and by engagement of the bearings 22 with vertical surfaces 28C of the wedges (that are opposite to the incline surfaces 28B of the wedges).

As the wedges 28 are lifted, the incline surfaces 28B urge the followers 34 outwardly, turning the pivot members 32 so as to move the inner jaws 20B generally radially (horizontally) into engagement with corresponding inner surfaces of the sidewall 14 of the container, thereby simultaneously closing the clamps 20 upon the sidewall. If the outer jaws 20A of the clamps are spaced slightly from corresponding outer surfaces of the sidewall 14 when the clamps are open, the sidewall must give slightly to permit the clamps to close upon the sidewall.

After the clamps have closed upon the sidewall, the clamps grip the sidewall frictionally. Continued raising of the lifting member 18 lifts the container 12, with the container suspended from the lifting apparatus 10.

The weight of the container and/or its contents provides a downward force in opposition to the upward force applied to the lifting member 18. The wedging action provided by the incline surfaces 28B of the wedges and the associated followers 34 increases the clamping pressure on the sidewall as the container is lifted, ensuring that the container does not slip from the jaws of the clamps 20.

A second embodiment of the invention is shown in FIGS. 10-13. While the first embodiment employs a wedging action to increase the clamping pressure as the container is lifted, the second embodiment employs a levering action for this purpose.

FIGS. 10 and 11 show the lifting apparatus 60 positioned over the top edge 14A of the sidewall 14 of a cylindrical container 12. The apparatus comprises a frame 62 and a pair of linkages 66 comprising first links 68 and second links 70. The frame has a pair of parallel frame parts 62A,62B joined in a conventional manner. The frame parts are assembled with pivots 64 for the first links 68 and are connected by transverse walls 62C (FIG. 13).

Outer jaws 20A of clamps 20 are fixed to the frame 62, while inner jaws 20B of the clamps are fixed to the first links 68. The jaws may be shaped like those of the first embodiment.

Each first link 68 comprises a pair of parallel link parts 68A,68B embracing a corresponding end of the frame 62 and mounted thereon by pivots 64 intermediate the ends of the first links. One end of each first link 68 supports an inner jaw 20B. The opposite end of each first link is connected by a pivot 72 to one end of a corresponding second link 70, the opposite end of which is connected by a pivot 73 to a lifting member 74. In the form shown the lifting member is a rectangular cross-section tube. Each second link 70 comprises a pair of parallel link parts 70A,70B embracing the lifting member 74 and embraced by the parts of the corresponding first link 68. The parallel parts of the respective links are joined to one another by the associated pivots.

As shown in FIG. 11, when the clamps 20 are fully open, the linkages 66 are disposed such that the second links 70 are substantially juxtaposed with the frame 62, horizontally. A latch is provided to maintain this position. In the form shown, the latch comprises a U-shaped pin 78 (see FIG. 13) one leg 78A of which passes through a hole in a bracket portion 62D of the frame, through a hole in a frame part 62A and into a hole of the lifting member tube 74. A coil spring 80 biases the latch to insert the leg 78A of the pin through the aligned holes.

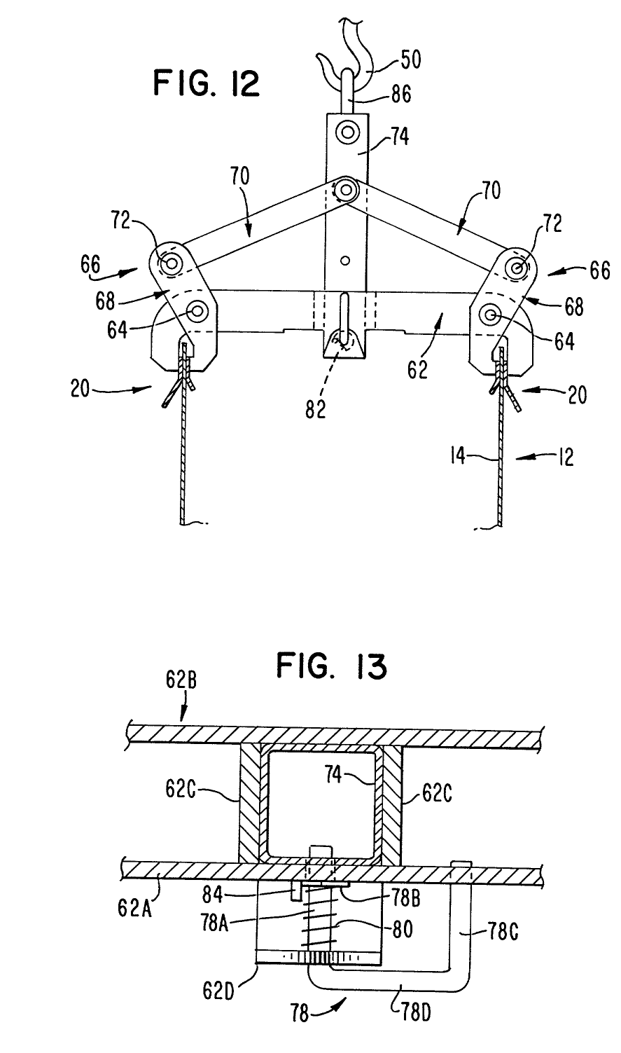

A disk 78B fixed to the leg 78A has a circumferential notch 82 cooperating with an abutment 84 projecting from the frame. One end of the notch engages the abutment when the plane of the latch pin 78 is horizontal and a leg 78C of the latch pin extends under the frame, as shown in FIGS. 10, 11, and 13. To release the latch, the base 78D of the U-shaped pin is pulled to extract the leg 78A from the hole in the lifting member tube 74. The latch pin is then turned so that the tip of leg 78C rests against the side of the frame (see FIG. 12), and the opposite end of the notch 82 in the disk 78B engages the abutment 84.

As shown in FIGS. 11 and 12, the top of the lifting member is provided with a ring 86 that can be engaged with a hook 50 of a hoist or other power lift mechanism for raising the lifting member 74 relative to the frame 62. The inner surfaces of the frame surrounding the lifting member may be treated to facilitate sliding of the lifting member relative to the frame. When the latch is released, and the lifting member 74 is raised, the linkages 66 turn the first links 68 to move the inner jaws 20B into engagement with corresponding inner surfaces of the sidewall 14 of the container. As in the first embodiment, the movement of the inner jaws is generally radial (horizontal) with respect to a cylindrical sidewall.

Also, as in the first embodiment, the clamps 20 close simultaneously to grip the sidewall 14 frictionally. The weight of the frame 62 and the first links 68 is sufficient to maintain the lifting apparatus 60 on top of the container sidewall as the lifting member is initially raised relative to the frame. After the clamps have closed to grip the sidewall, continued raising of the lifting member increases the clamping pressure on the sidewall and lifts the container. Furthermore, as in the first embodiment, the weight of the container and/or its contents provides a downward force that opposes the upward lifting force and increases the clamping pressure by virtue of the levering action (mechanical advantage) of the linkages.

As is apparent from the foregoing description of the embodiments of the invention, the lifting apparatus is designed to create sufficient frictional clamping force on the walls of a container (which may be empty or filled) to allow lifting of a container and its contents without requiring container formations, such as beading, crimping, or depressions, for engagement with lifting elements, thereby avoiding possible damage to any such wall formations. Nevertheless, the apparatus of the invention can be used to lift containers having such formations, without engaging such formations.

In the first embodiment of the invention, a lifting mechanism comprises the lifting member, the pivot members, the wedges, and the followers to close the clamps when the lifting member is raised. In the second embodiment of the invention, a lifting mechanism comprises the lifting member and linkages (levers) to close the clamps. These lifting mechanisms utilize mechanical advantage or force multiplication beneficially. Other types of mechanisms including levers, toggles, torque arms and inclined planes, for example, may also be employed.

In both of the first and second embodiments, the outer jaws of the clamps are fixed to a frame and the inner jaws of the clamps are moved relative to the outer jaws. This arrangement has the advantage of simplicity, and it facilitates the proper alignment of the lifting apparatus on top of a container.

In implementations of the lifting apparatus of the invention, the principal parts (including the jaws of the clamps) have been made of steel, but other suitable materials may be employed. Also, in the second embodiment a housing may be attached to the frame so as to enclose the second links.

While preferred embodiments of the invention have been shown and described, it will be apparent to those skilled in the art that changes can be made without departing from the principles and spirit of the invention, the scope of which is defined in the following claims. For example, although two clamps are used in the first and second embodiments, more than two clamps may be employed in the lifting apparatus. Also, the lifting apparatus can be employed to lift loads other than containers having a bottom wall. Broadly, the apparatus can be used to lift a load having an upright tubular sidewall, such as a vertical section of pipe.

What is claimed is:

1. Apparatus for lifting a load having an upright tubular sidewall, comprising:
a plurality of clamps constructed and disposed to grip spaced sidewall portions, each of the clamps having cooperable, relatively movable outer and inner jaws shaped to conform to the shape of the respective sidewall portions, the outer jaws being disposed to engage outer surfaces of the respective sidewall portions and the inner jaws being disposed to engage inner surfaces of the respective sidewall portions; and
a lifting mechanism constructed to close the clamps to grip the respective sidewall portions frictionally and then to raise the lifting apparatus with the load suspended from the clamps.

2. Apparatus according to claim 1, wherein the outer jaws are fixed to a frame, and the inner jaws are supported on the frame for movement relative to the outer jaws.

3. Apparatus according to claim 1, wherein the clamps are constructed and disposed to grip opposite sidewall portions.

4. Apparatus according to claim 1, wherein the lifting mechanism is operatively connected to the inner jaws and is constructed to move the inner jaws into engagement with inner surfaces of the sidewall portions.

5. Apparatus according to claim 1, wherein the apparatus has elements that support the apparatus on a top edge of the sidewall when the apparatus is positioned relative to the load for lifting.

6. Apparatus according to claim 1, wherein the lifting mechanism comprises a frame and a lifting member movable vertically relative to the frame, and the clamps are closed in response to upward movement of the lifting member relative to the frame.

7. Apparatus according to claim 6, wherein the lifting mechanism includes linkages that connect the jaws of the clamps to the lifting member and that move to close the clamps when the lifting member is raised.

8. Apparatus according to claim 6, wherein the lifting mechanism includes a pair of incline surfaces that move followers when the lifting member is raised, and thereby close the clamps.

9. Apparatus according to claim 8, wherein the incline surfaces are part of wedge members mounted on the lifting member so as to move upwardly when the lifting member is raised, and the followers are mounted on pivot members pivotally supported on the frame, one of the jaws of each clamp being mounted on a respective pivot member and the other jaw of each clamp being fixed to the frame.

10. Apparatus according to claim 6, wherein the inner jaws are mounted on pivot members that are pivotally supported on the frame, and wherein the lifting member has a pair of wedges mounted thereon adjacent to the respective pivot members, each pivot member having a follower thereon engaging an incline surface of a respective wedge so that when the wedges are moved upwardly by the lifting member, the upward movement of the wedges is converted to pivotal movement of the pivot members and the inner jaws are moved toward the outer jaws to close the clamps on the sidewall portions, and then continued upward movement of the lifting member lifts the load.

11. Apparatus according to claim 10, wherein the wedges have guide surfaces, spaced from the incline surfaces and engaging guide members mounted on the frame for guiding movement of the wedges relative to the frame, and wherein the lifting member has additional guide surfaces engaging guide members mounted on the frame for guiding movement of the lifting member relative to the frame.

12. Apparatus according to claim 10, wherein the frame comprises a pair of spaced plates and the lifting member comprises a plate disposed between the plates of the frame.

13. Apparatus according to claim 6, wherein the inner jaws are mounted on first end portions of respective first links pivotally supported on the frame at intermediate regions of the first links, and wherein the lifting mechanism includes the first links and second links pivotally connected between respective second end portions of the first links and the lifting member.

14. Apparatus according to claim 13, wherein the frame comprises a pair of parallel frame parts, each of the first links comprises a pair of parallel link parts disposed adjacent to respective frame parts, and each of the second links comprises a pair of parallel link parts disposed adjacent to respective first link parts.

15. Apparatus according to claim 13, wherein the apparatus has a releasable latch for holding the links in positions that maintain the clamps open.

16. Apparatus according to claim 6, wherein the apparatus has a releasable latch for holding the lifting member at a position relative to the frame at which the clamps are open.

17. Apparatus according to claim 16, wherein the releasable latch comprises a pin insertable through corresponding holes in the lifting member and the frame.

18. Apparatus according to claim 1, wherein jaws of the clamps have tapered lead-in portions to facilitate placement of the clamps over an upper edge of the sidewall portions.

19. Apparatus according to claim 1, wherein the apparatus includes handles for manually positioning the apparatus relative to a container.

20. A method of lifting a load having spaced sidewall portions, comprising:
disposing a plurality of clamps adjacent to respective sidewall portions, each clamp having cooperable, relatively movable outer and inner jaws shaped to conform to the shape of the respective sidewall portions, the outer jaws being disposed to engage outer surfaces of the respective sidewall portions and the inner jaws being disposed to engage inner surfaces of the respective sidewall portions;
moving the jaws of each clamp to close the clamps to grip respective sidewall portions frictionally; and
lifting the clamps so as to lift the load with the load suspended from the clamps.

21. A method according to claim 20, further comprising increasing clamping pressure between the jaws of each clamp in response to lifting of the load.

22. A method according to claim 21, wherein the increasing of the clamping pressure is due to a levering action that urges one of the jaws of each clamp toward the other jaw of each clamp.

23. A method according to claim 21, wherein the increasing of the clamping pressure is due to a wedging action that urges one of the jaws of each clamp toward the other jaw of each clamp.

24. A method according to claim 21, wherein the clamps are supported on a frame, and prior to closing the clamps on the respective sidewall portions the frame is supported on a top edge of the sidewall.

25. Lifting apparatus comprising a plurality of gripping devices having shaped surfaces for gripping spaced sidewall portions of a container between the surfaces of each gripping device, the surfaces being shaped to conform to the shape of the spaced sidewall portions and being actuated by the weight of the container and/or its contents as the container is lifted to create a gripping force on the sidewall portions that allows the container and any contents to be lifted with the container suspended from the shaped surfaces.

26. Lifting apparatus according to claim 25, wherein the gripping devices are actuated by mechanical advantage devices.

27. Lifting apparatus according to claim 25, wherein the gripping devices are constructed to lift containers having straight sidewalls extending to a top edge of the sidewalls, the sidewalls being free of crimping, beading, or other surface formations that would aid in lifting of the containers.

28. Lifting apparatus comprising clamp means including cooperable first and second jaws, a frame, and a lifting member movable relative to the frame, the first jaw being fixed to the frame and the second jaw being mounted on a pivot member pivotally supported on the frame, and incline surface means fixed to the lifting member, the pivot member having a follower that engages the incline surface means to move the second jaw toward the first jaw in response to movement of the lifting member relative to the frame.

29. Lifting apparatus comprising a pair of spaced clamps, a frame, and a lifting member movable relative to the frame, each clamp having a first jaw fixed to the frame and a second jaw mounted on a pivot member pivotally supported on the frame, and a pair of incline surface members fixed to the lifting member, the pivot members having followers cooperable with the incline surface members, respectively, for moving the second jaws toward the first jaws when the lifting member is moved relative to the frame.

30. Lifting apparatus comprising a frame, a pair of spaced clamps, each clamp having cooperable first and second jaws, a pair of linkages, and a lifting member movable relative to the frame, the first jaws being fixed to the frame, and the second jaws being fixed to first links of the linkages, respectively, the first links being pivotally mounted on the frame and being pivotally connected to second links of the linkages, respectively, that are pivotally connected to the lifting member, the linkages being constructed to move the second jaws toward the first jaws in response to movement of the lifting member relative to the frame.
